(19) United States
(12) Patent Application Publication
(10) Pub. No.: US 2020/0247548 A1
(43) Pub. Date: Aug. 6, 2020

(54) APPARATUS AND METHODS FOR PROVIDING AIR TO PNEUMATIC LOADS ONBOARD AIRCRAFT

(71) Applicant: BOMBARDIER INC., Dorval (CA)

(72) Inventors: Sandro Afonso Silva FAGUNDES, Pointe-Claire (CA); Issa IBRAHIM, Laval (CA)

(21) Appl. No.: 16/640,541

(22) PCT Filed: Aug. 21, 2018
(86) PCT No.: PCT/CA2018/051007

§ 371 Date: Feb. 20, 2020

Related U.S. Application Data
(60) Provisional application No. 62/549,205, filed on Aug. 23, 2017.

(51) Int. Cl. B64D 13/00; B64D 13/02; B64D 13/06; B64D 13/08; B64D 15/04

(52) U.S. Cl. CPC B64D 13/00; B64D 13/02; B64D 13/06; B64D 2013/0644; B64D 15/04; B64D 2013/0607; B64D 2013/0618; B64D 13/08

(57) ABSTRACT

Apparatus and methods for providing air to pneumatic loads such as an environmental control system for a passenger cabin of an aircraft or an ice protection device of the aircraft are disclosed. In one embodiment, the apparatus comprises: a compressor configured to produce a first quantity of compressed air onboard the aircraft; and a heat exchanger configured to facilitate heat transfer from the first quantity of compressed air to a quantity of cooling air. The heat exchanger can be operatively connected to supply the cooled first quantity of compressed air to a cabin of the aircraft and supply the heated quantity of cooling air to an ice protection device of the aircraft. In some embodiments, the apparatus and methods disclosed herein can reduce or eliminate the need for the extraction of compressed bleed air from an engine of the aircraft.

### CROSS-REFERENCE TO RELATED APPLICATION(S)

This International PCT Patent Application relies for priority on U.S. Provisional Patent Application Ser. No. 62/549,205 filed on Aug. 23, 2017, the entire content of which is incorporated herein by reference.

### TECHNICAL FIELD

The disclosure relates generally to aircraft, and more particularly to pneumatic systems onboard aircraft.

### BACKGROUND

Passenger aircraft typically have an environmental control system (ECS) to pressurize and provide temperature control and ventilation to a passenger cabin of the aircraft. Passenger aircraft also often have an ice protection system. Some architectures of aircraft ice protection systems use heated air to provide ice protection to one or more exterior surfaces (e.g., leading edges) of the aircraft. Compressed air known as “bleed air” extracted from a compressor of an aircraft engine is typically used to supply these systems. The bleed air is typically extracted from a relatively high-pressure compressor stage of the aircraft engine. The extracted bleed air is typically conditioned prior to being directed into the passenger cabin or to an ice protection device. The conditioning of the bleed air prior to use by the applicable pneumatic systems can result in some energy (e.g., heat) carried by the bleed air being wasted. The extraction of bleed air from an aircraft engine, even if relatively small, is an energy draw from the engine and can affect the efficiency and hence the fuel economy of the engine. Improvement is desirable.

### SUMMARY

In one aspect, the disclosure describes an apparatus for providing air to pneumatic loads onboard an aircraft. The apparatus comprises:

a first compressor configured to produce a first quantity of compressed air onboard the aircraft and being operatively connected to supply the first quantity of compressed air to a cabin of the aircraft; and

a second compressor configured to produce a second quantity of compressed air onboard the aircraft and being operatively connected to:

supply the second quantity of compressed air to the cabin of the aircraft when an altitude of the aircraft is above a threshold altitude; and

supply the second quantity of compressed air to an ice protection device of the aircraft when the altitude of the aircraft is below the threshold altitude.

The first compressor may be configured to receive ram air to produce the first quantity of compressed air.

The second compressor may be configured to receive ram air to produce the second quantity of compressed air.

The apparatus may comprise an electric motor for driving the first compressor.

The apparatus may comprise an electric motor for driving the second compressor.

The apparatus may comprise a heat exchanger configured to facilitate heat transfer from the first quantity of compressed air upstream of the cabin to a quantity of cooling air. The ice protection device may be operatively connected to receive the heated quantity of cooling air from the heat exchanger.

The apparatus may comprise a third compressor configured to compress the heated quantity of cooling air upstream of the ice protection device.

The apparatus may comprise a mixing chamber configured to receive the compressed heated quantity of cooling air from the third compressor and the second quantity of compressed air to provide a mixed quantity of air for ice protection.

The apparatus may comprise:

a heat exchanger configured to facilitate heat transfer from the first quantity of compressed air upstream of the cabin to a quantity of cooling air, the ice protection device being operatively connected to receive the heated quantity of cooling air from the heat exchanger;

a third compressor configured to compress the heated quantity of cooling air upstream of the ice protection device; and

an electric motor for driving the third compressor.

The cooling air may be ram air.

The first compressor and/or the second compressor may be non-aircraft-engine compressors.

Embodiments may include combinations of the above features.

In another aspect, the disclosure describes a method for providing air to pneumatic loads onboard an aircraft. The method comprises:

producing a first quantity of compressed air using a first compressor onboard the aircraft;

using the first quantity of compressed air to control an environment inside a cabin of the aircraft;

producing a second quantity of compressed air using a second compressor onboard the aircraft;

using the second quantity of compressed air to control the environment inside the cabin of the aircraft when an altitude of the aircraft is above a threshold altitude; and

using the second quantity of compressed air for ice protection when the altitude of the aircraft is below the threshold altitude.

The method may comprise receiving ram air at the first compressor to produce the first quantity of compressed air.

The method may comprise receiving ram air at the second compressor to produce the second quantity of compressed air.

The method may comprise driving the first compressor using an electric motor.

The method may comprise driving the second compressor using an electric motor.

The method may comprise:

transferring heat from the first quantity of compressed air to a quantity of cooling air prior to using the first quantity of compressed air to control the environment inside the cabin of the aircraft; and

using the heated quantity of cooling air for ice protection.

The method may comprise compressing the heated quantity of cooling air using a third compressor before using the compressed heated quantity of cooling air for ice protection.

The method may comprise:

mixing the compressed heated quantity of cooling air with the second quantity of compressed air to provide a mixed quantity of air; and

using the mixed quantity of air for ice protection.

The method may comprise:

transferring heat from the first quantity of compressed air to a quantity of cooling air prior to using the first quantity of compressed air to control the environment inside the cabin of the aircraft;

compressing the heated quantity of cooling air using a third compressor driven by an electric motor; and

using the compressed heated quantity of cooling air for ice protection.

The cooling air may be ram air.

The first compressor and/or the second compressor may be non-aircraft-engine compressors.

Embodiments may include combinations of the above features.

In a further aspect, the disclosure describes an apparatus for providing air to pneumatic loads onboard an aircraft. The apparatus may comprise:

a first compressor configured to produce a first quantity of compressed air onboard the aircraft; and

a heat exchanger configured to facilitate heat transfer from the first quantity of compressed air to a quantity of cooling air and being operatively connected to:

supply the cooled first quantity of compressed air to a cabin of the aircraft; and

supply the heated quantity of cooling air to an ice protection device of the aircraft.

The apparatus may comprise another compressor configured to compress the heated quantity of cooling air upstream of the ice protection device.

The quantity of cooling air may be ram air.

The first compressor may be configured to receive ram air to produce the first quantity of compressed air.

The quantity of cooling air may be ram air.

The apparatus may comprise a respective electric motor for driving each of the first compressor and the other compressor.

The first compressor may be configured to receive a first quantity of ram air to produce the first quantity of compressed air. The apparatus may comprise:

a second compressor configured to receive a second quantity of ram air to produce a second quantity of compressed air onboard the aircraft;

a third compressor configured to compress the heated quantity of cooling air; and

a mixing chamber configured to receive the compressed heated quantity of cooling air from the third compressor and the second quantity of compressed air to provide a mixed quantity of air for ice protection.

The quantity of cooling air may comprise a third quantity of ram air.

The apparatus may comprise:

a first electric motor for driving the first compressor;

a second electric motor for driving the second compressor; and

a third electric motor for driving the third compressor.

The first compressor may be a non-aircraft-engine compressor.

Embodiments may include combinations of the above features.

In a further aspect, the disclosure describes a method for providing air to pneumatic loads onboard an aircraft. The method comprises:

producing a first quantity of compressed air using a first compressor onboard the aircraft;

cooling the first quantity of compressed air by transferring heat from the first quantity of compressed air to a quantity of cooling air;

using the cooled first quantity of compressed air to control an environment inside a cabin of the aircraft; and

using the heated quantity of cooling air for ice protection.

The method may comprise compressing the heated quantity of cooling air using another compressor onboard the aircraft before using the compressed heated quantity of cooling air for ice protection.

The quantity of cooling air may be ram air.

The method may comprise receiving ram air at the first compressor to produce the first quantity of compressed air.

The quantity of cooling air may be ram air.

The method may comprise driving each of the first compressor and the other compressor using an electric motor.

The method may comprise:

receiving a first quantity of ram air at the first compressor to produce the first quantity of compressed air;

receiving a second quantity of ram air at a second compressor onboard the aircraft to produce a second quantity of compressed air;

compressing the heated quantity of cooling air using a third compressor onboard the aircraft;

mixing the heated quantity of cooling air with the second quantity of compressed air to provide a mixed quantity of air; and

using the mixed quantity of air for ice protection.

The quantity of cooling air may comprise a third quantity of ram air.

The method may comprise:

driving the first compressor using a first electric motor;

driving the second compressor using a second electric motor; and

driving the third compressor using a third electric motor.

The first compressor may be a non-aircraft-engine compressor.

Embodiments may include combinations of the above features.

In another aspect, the disclosure describes an aircraft comprising an apparatus as defined herein.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of an exemplary aircraft comprising an apparatus for providing air to pneumatic loads onboard an aircraft;

FIG. 2 is a schematic representation of an exemplary embodiment of the apparatus for providing air to pneumatic loads onboard an aircraft;

FIG. 3 is a schematic representation of another exemplary embodiment of the apparatus for providing air to pneumatic loads onboard an aircraft;

FIG. 4 is a schematic representation of an exemplary mixing chamber of the apparatus of FIG. 3;

FIG. 5 is a flowchart illustrating an exemplary method for providing air to pneumatic loads onboard an aircraft; and

FIG. 6 is a flowchart illustrating another exemplary method for providing air to pneumatic loads onboard an aircraft.

### DETAILED DESCRIPTION

This disclosure relates to apparatus and methods for providing air to pneumatic loads onboard an aircraft. In various embodiments, the apparatus and methods disclosed herein can reduce or eliminate the need for extracting bleed air from a compressor section of one or more thrust-producing engines of the aircraft. In some situations, such reduction in requirement for bleed air can result in efficiency improvements of the aircraft engine(s) compared to other arrangements that rely more heavily on bleed air. In some situations, such reduction in requirement for bleed air can potentially result in weight reduction due to the reduction or elimination of components (e.g., pre-cooler and fan air control valves) typically associated with bleed air systems. In some embodiments, the apparatus and methods disclosed herein make use of one or more (e.g., electrically-driven) compressors that are not part of a thrust-producing engine of the aircraft to provide a source of compressed air for supplying one or more pneumatic loads (e.g., ice protection system and/or environmental control system). Such compressors are referred herein as “non-aircraft-engine” compressors and can be used to supply pneumatic loads on an on-demand basis and independently of engine thrust settings. In some embodiments, ram air can be fed to the one or more compressors.

Aspects of various embodiments are described through reference to the drawings.

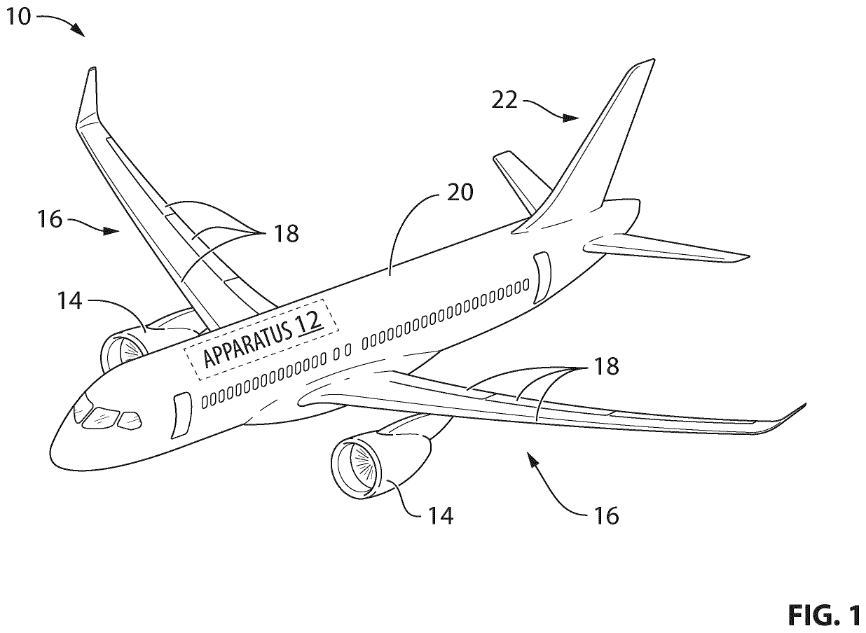

FIG. 1 is a perspective view of an exemplary aircraft 10 which can comprise apparatus 12 (shown schematically) for supplying air to aircraft systems. As explained below, apparatus 12 may be used to supply air to one or more pneumatic loads onboard of aircraft 10. The term “pneumatic load” as used herein is intended to encompass any device or system of aircraft 10 that consumes compressed air. Aircraft 10 can be any suitable type of aircraft such as corporate (e.g., business jet), private, commercial and passenger aircraft. For example, aircraft 10 can be a narrow-body, twin-engine jet airliner. Aircraft 10 can be a fixed-wing aircraft. Aircraft 10 can comprise one or more wings 16 including one or more flight control surfaces 18, fuselage 20, one or more engines 14 and empennage 22. One or more of engines 14 can be mounted to one or more of wings 16. Alternatively, or in addition, one or more of engines 14 can be mounted to fuselage 20 or be installed on aircraft 10 in any suitable manner. In some embodiments, one or more engines 14 can be mounted to a tail of aircraft 10.

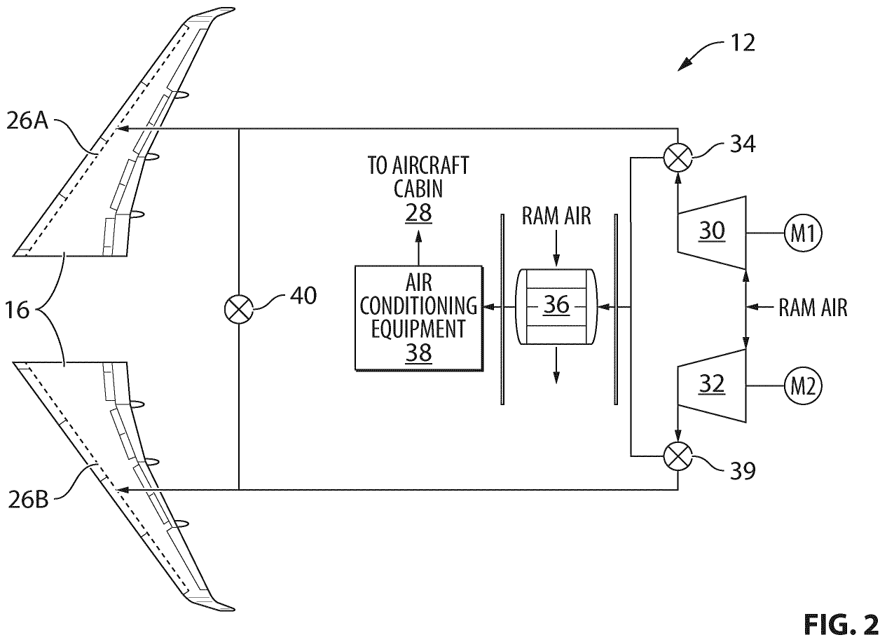

FIG. 2 is a schematic representation of an exemplary embodiment of apparatus 12 for providing conditioned (e.g., compressed, heated) air to pneumatic loads onboard of aircraft 10. In various embodiments, apparatus 12 as described herein can comprise part(s) of one or more pneumatic systems of aircraft 10. In some embodiments, apparatus 12 can provide compressed air without requiring bleed air to be extracted from thrust-producing engines 14 of aircraft 10. While exemplary pneumatic loads disclosed herein include one or more ice protection devices 26A, 26B (referred generically herein as “ice protection device 26”) and a passenger cabin 28, it is understood that aspects of apparatus 12 and the methods disclosed herein can also apply to other pneumatic loads onboard of aircraft 10.

Apparatus 12 can, for example, comprise part of an environmental control system (ECS) of aircraft 10 and/or of an ice protection system of aircraft 10. The ECS can be configured to provide fresh air supply, thermal control and cabin pressurization for the flight crew and passengers of aircraft 10. The ice protection system can be configured to use (e.g., hot) air that is routed to leading edges of wing(s) 16 or to inlet lips of nacelles of engines 14 for example to remove an accumulation of ice (i.e., de-icing), or, to prevent such accumulation of ice in the first place (i.e., anti-icing). For example, the ice protection system can comprise pneumatic de-icing boots that rely on compressed air or can comprise an anti-icing system that keeps some surfaces of aircraft 10 above a freezing temperature. For example, in some embodiments, each wing 16 can comprise a piccolo duct that distributes the hot bleed air along a protected region of the wing leading edge. After being used to heat the leading edge, the air is then exhausted via holes usually in a lower surface of wing 16.

In various embodiments, apparatus 12 can comprise first compressor 30 configured to produce a first quantity of compressed air onboard aircraft 10 and second compressor 32 configured to produce a second quantity of compressed air onboard aircraft 10. First compressor 30 can be operatively connected to supply the first quantity of compressed air to cabin 28 of aircraft 10. For example, first compressor 30 can be operatively connected to cabin 28 via one or more valves 34, heat exchanger 36 and optionally other air conditioning equipment 38 that may be part of the ECS of aircraft 10.

In some embodiments, the operation and use of second compressor 32 can depend on the operating condition of aircraft 10 and the demand for air from the pneumatic load(s) of aircraft 10. For example, the demand for air from the ECS of aircraft 10 can be higher at higher altitudes for maintaining pressurization of passenger cabin 28 at higher altitudes. On the other hand, icing protection may not be required at higher altitudes due to the environmental conditions at such higher altitudes not being prone to causing ice accumulation on outer surfaces of aircraft 10. Accordingly, the use of second compressor 32 can depend on the altitude of aircraft 10. For example, at a higher altitude where ice protection is not required but the pneumatic load associated with passenger cabin 28 is higher, the second quantity of compressed air produced by second compressor 32 can be supplied to passenger cabin 28. Alternatively, at a lower altitude where ice protection can be required (e.g., depending on environmental conditions) but the pneumatic load associated with passenger cabin 28 is lower, the second quantity of compressed air produced by second compressor 32 can be supplied to ice protection device 26 instead of passenger cabin 28.

Accordingly, the use of the second quantity of compressed air produced by second compressor 32 can be determined based on an altitude of aircraft 10. For example, second compressor 32 can be operatively connected to supply the second quantity of compressed air to passenger cabin 28 when an altitude of the aircraft is above a threshold altitude and to supply the second quantity of compressed air to ice protection device 26 when the altitude of aircraft 10 is below the threshold altitude. In some embodiments, the threshold altitude can be between about 20,000 ft and about 25,000 ft above sea level, for example.

Second compressor 32 can be operatively connected to either supply compressed air to passenger cabin 28 or to ice protection device 26 via one or more valves 39 for example. In some embodiments, second compressor 32 can be operatively connected to simultaneously supply compressed air to both passenger cabin 28 and to ice protection device 26 in some situations. In reference to the schematic illustration of FIG. 2, this can be represented by valve 39 being a multi-port (e.g., 3-way) valve where one portion of the compressed air produced by second compressor 32 can be supplied to passenger cabin 28 and another portion of the compressed air produced by second compressor 32 can simultaneously be supplied to ice protection device 26.

In order to provide functional redundancy, first and second compressors 30 and 32 may be similarly or substantially identically configured to be operatively connected to supply compressed air to passenger cabin 28 and/or to ice protection device 26. For example, valve 34 can be configured to direct compressed air from first compressor 30 to either passenger cabin 28 or to ice protection device 26. In some embodiments, valve 34 may also be a multi-port (e.g., 3-way) valve where one portion of the compressed air produced by first compressor 30 can be supplied to passenger cabin 28 and another portion of the compressed air produced by first compressor 30 can simultaneously be supplied to ice protection device 26.

In one mode of operation, first compressor 30 can be operatively connected to supply compressed air to ice protection device 26A of one wing 16 and second compressor 32 can be operatively connected to supply compressed air to ice protection device 26B of the other wing 16. However, in order to provide functional redundancy, apparatus 12 can comprise one or more cross-over valves 40 that permit first compressor 30 and/or second compressor 32 to supply both ice protection devices 26A and 26B with compressed air in some situations.

In various embodiments, first and second compressors 30 and 32 can be non-aircraft-engine compressors so that first and second compressors 30 and 32 can be operated substantially independently of the operation of thrust-producing engines 14 of aircraft 10. For example, first compressor 30 can be driven by electric motor M1 and second compressor 32 can be driven by electric motor M2. Electric motors M1 and M2 can be powered by a suitable electric source (e.g., electric power bus) onboard of aircraft 10. Such electric source can include an electric generator driven by one of engines 14, an electric generator driven by an auxiliary power unit (APU), an electric generator driven by a ram air turbine (RAT) and/or one or more batteries for example. First and second compressors 30, 32 can be operated on an on-demand basis.

Heat exchanger 36 can be configured to facilitate heat transfer from the first (and/or second) quantity of compressed air downstream compressors 30 and/or 32 and upstream of air conditioning equipment 38 to a quantity of cooling fluid such as air. Heat exchanger 36 can serve to remove some of the heat from the first and/or second quantities of compressed air that was added during pressurization via compressors 30, 32. Accordingly, heat exchanger 36 can serve to at least partially condition the compressed air to a level that is suitable for use in aircraft cabin 28 for example.

In some embodiments, first compressor 30 can be configured to receive a first quantity of ram air to produce the first quantity of compressed air. Similarly, second compressor 32 can be configured to receive a second quantity of ram air to produce the second quantity of compressed air. In some embodiments, the cooling air used by heat exchanger 36 can also be ram air. The quantities of ram air provided to first compressor 30, second compressor 32 and to heat exchanger 36 can be supplied via one or more suitable ram air intakes (not shown) provided at one or more locations on aircraft 10. In some embodiments, each quantity of ram air can be supplied by a respective ram air intake. Alternatively, one common ram air intake can be used to supply ram air to two or more of first compressor 30, second compressor 32 and heat exchanger 36. In the embodiment of FIG. 2, the heated ram air that has passed through heat exchanger 36 may be discharged to the atmosphere or may be reused for ice protection or other purpose.

It is understood that apparatus 12 can comprise one or more controllers (not shown) operatively connected to various components (e.g., motors M1 and M2, valves 34, 39, 40) of apparatus 12 for the purpose of controlling at least some aspect of operation of apparatus 12. For example, such controller(s) can comprise any suitable data processor, computer, programmable data processing apparatus, logic circuit or other devices to cause a series of operational steps to be performed to produce a computer implemented process based on machine-readable instructions and suitable input data. Such input data can comprise pilot input, environmental condition(s) (e.g., ambient temperature) in which aircraft 10 is operating and/or operational condition(s) such as the altitude of aircraft 10 and/or parameters associated with passenger cabin 28 of aircraft 10. For example, such input data may be useful in determining whether the environmental conditions are susceptible to causing icing and consequently determining if the operation of ice protection device 26 is required. Such controller(s) can be operatively connected to one or more sensors for providing such input data. Such controller(s) can comprise suitable storage media storing instructions such as computer-readable program code for carrying out operations for aspects of the present disclosure and can be written in any combination of one or more programming languages. In some embodiments, such controller(s) can be part of an air management system of aircraft 10 associated with one or more pneumatic loads onboard of aircraft 10.

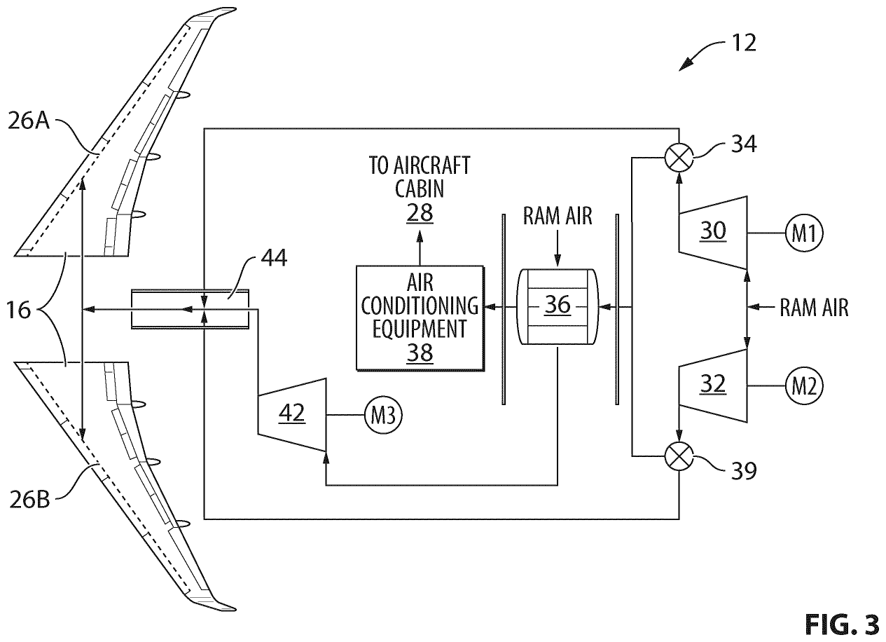

FIG. 3 is a schematic representation of another exemplary embodiment of apparatus 12 for providing air to pneumatic loads onboard aircraft 10. The embodiment of FIG. 3 includes elements already described above in relation to the embodiment of FIG. 2 and such description is not repeated. Aspects of the embodiment of FIG. 2 are also applicable to the embodiment of FIG. 3.

In reference to FIG. 3, first and second compressors 30, 32 can be configured to supply compressed air to passenger cabin 28 and/or to ice protection device 26. The compressed air produced by first compressor 30 and/or second compressor 32 can be cooled via heat exchanger 36 at a location upstream of passenger cabin 28. The ram air serving as a cooling fluid and that is heated by passing through heat exchanger 36 can subsequently be used for ice protection. In some situations, it can be desirable to further compress and consequently further heat the heated ram air exiting heat exchanger 36 via third compressor 42 located upstream of ice protection device 26 prior to using the heated ram air for ice protection. Third compressor 42 can be driven by electric motor M3. Third compressor 42 can also be a non-aircraft-engine compressor.

In some embodiments, apparatus 12 can be configured so that in some situations, the heated ram air that has passed through heat exchanger 36 is used as the only source of air for ice protection device 26. Alternatively, apparatus 12 can be configured so that the heated ram air exiting heat exchanger 36 is used in combination with compressed air from first and/or second compressors 30, 32 for ice protection. Apparatus 12 can comprise mixing chamber 44 in which heated ram air exiting third compressor 42 is combined with compressed air from first and/or second compressors 30, 32 to form a mixed quantity of air that is then used for ice protection. The quantities of air from each source entering mixing chamber 44 can be adjusted based on requirements of ice protection device 26 and on the conditions (e.g., temperatures, pressures and flow rates) of the respective sources of air to produce a mixed quantity of air that is suitably conditioned for use by ice protection device 26. It is understood that apparatus 12 can comprise additional components that are not shown herein for the sake of clarity.

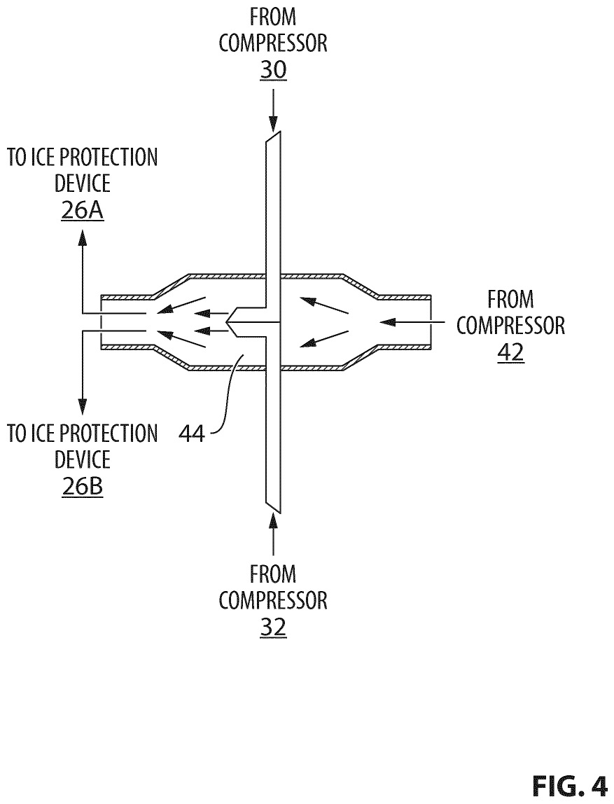

FIG. 4 is a schematic representation of an exemplary mixing chamber 44 of apparatus 12 where compressed and heated ram air from third compressor 42 is mixed with compressed air produced by first compressor 30 and/or by second compressor 32 to produce a mixed quantity of air suitable for use for ice protection. Mixing chamber 44 can be configured as an ejector.

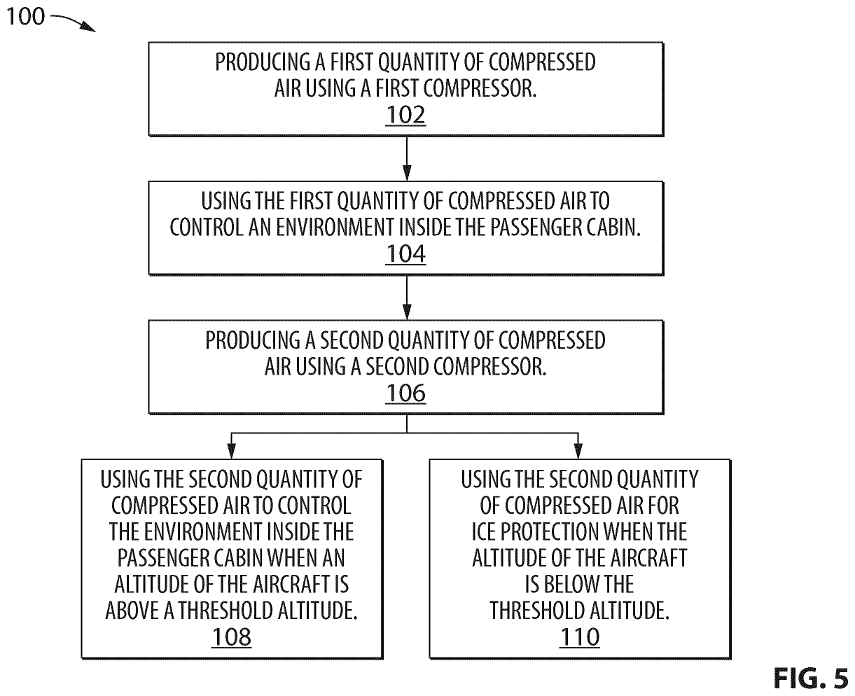

FIG. 5 is a flowchart illustrating an exemplary method 100 for providing air to pneumatic loads onboard aircraft 10. Method 100 can be performed using apparatus 12 as described herein or using another suitable apparatus. Aspects of apparatus 12 described above can also apply to method 100. Method 100 can comprise:

producing a first quantity of compressed air using first compressor 30 onboard aircraft 10 (see block 102);

using the first quantity of compressed air to control an environment inside passenger cabin 28 of aircraft 10 (see block 104);

producing a second quantity of compressed air using second compressor 32 onboard aircraft 10 (see block 106);

using the second quantity of compressed air to control the environment inside passenger cabin 28 of aircraft 10 when an altitude of aircraft 10 is above a threshold altitude (e.g., 20,000 ft) (see block 108); and

using the second quantity of compressed air for ice protection when the altitude of aircraft 10 is below the threshold altitude (see block 110).

In some embodiments, method 100 can comprise receiving a first quantity of ram air at first compressor 30 to produce the first quantity of compressed air. Method 100 can comprise receiving a second quantity of ram air at second compressor 32 to produce the second quantity of compressed air.

In some embodiments, first compressor 30 and second compressor 32 can each be driven using an electric motor M1, M2.

Method 100 can comprise transferring heat from the first quantity of compressed air to a quantity of cooling air prior to using the first quantity of compressed air to control the environment inside passenger cabin 28 of aircraft 10. In some embodiments, the heated quantity of cooling air can be used to provide ice protection. Method 100 can comprise compressing the heated quantity of cooling air using third compressor 42 before using the compressed heated quantity of cooling air for ice protection. In some embodiments, the compressed heated quantity of cooling air can be mixed with the second quantity of compressed air to provide a mixed quantity of air that is used for ice protection. In some embodiments, the supplied cooling air can be ram air.

First compressor 30, second compressor 32 and third compressor 42 can be non-aircraft-engine compressors.

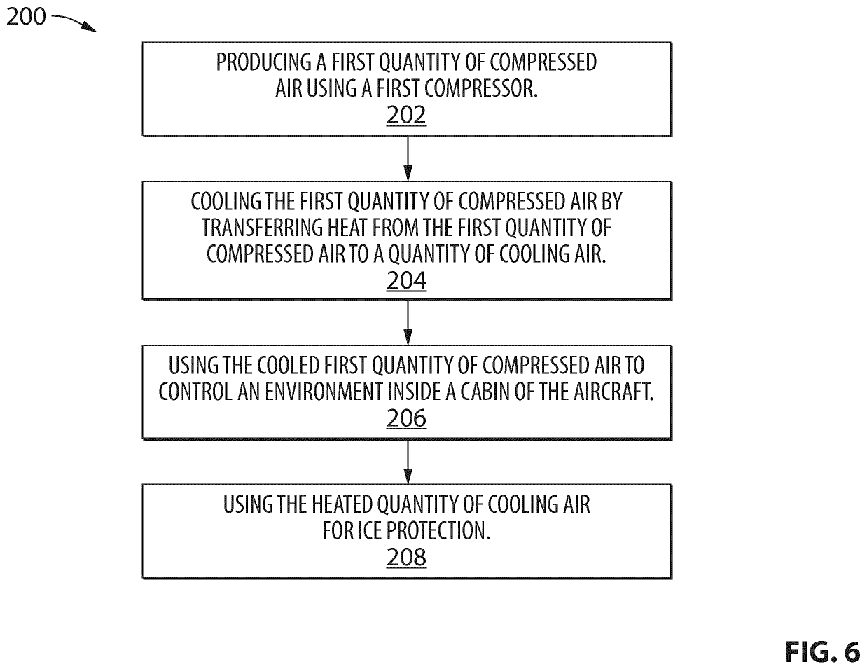

FIG. 6 is a flowchart illustrating another exemplary method 200 for providing air to pneumatic loads onboard aircraft 10. Method 200 can be performed using apparatus 12 as described herein or using another suitable apparatus. Aspects of apparatus 12 described above can also apply to method 200. Method 200 can comprise:

producing a first quantity of compressed air using first compressor 30 onboard aircraft 10 (see block 202);

cooling the first quantity of compressed air by transferring heat from the first quantity of compressed air to a quantity of cooling air (see block 204);

using the cooled first quantity of compressed air to control an environment inside passenger cabin 28 of aircraft 10 (see block 206); and

using the heated quantity of cooling air for ice protection (see block 208).

In some embodiments, method 200 can comprise compressing the heated quantity of cooling air using third compressor 42 onboard aircraft 10 before using the compressed heated quantity of cooling air for ice protection. The quantity of cooling air can be ram air.

Method 200 can comprise receiving a first quantity of ram air at first compressor 30 to produce the first quantity of compressed air.

In some embodiments, method 200 can comprise driving first compressor 30 and third compressor 42 using respective electric motors M1 and M3.

In some embodiments, method 200 can comprises:

receiving a first quantity of ram air at first compressor 30 to produce the first quantity of compressed air;

receiving a second quantity of ram air at second compressor 32 onboard aircraft 10 to produce a second quantity of compressed air;

compressing the heated quantity of cooling air using third compressor 42 onboard aircraft 10;

mixing the heated quantity of cooling air with the second quantity of compressed air to provide a mixed quantity of air; and

using the mixed quantity of air for ice protection.

The quantity of cooling air can comprise ram air.

Method 200 can comprise driving second compressor 32 using electric motor M2.

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

1. An apparatus for providing air to pneumatic loads onboard an aircraft, the apparatus comprising:
a first compressor configured to produce a first quantity of compressed air onboard the aircraft and being operatively connected to supply the first quantity of compressed air to a cabin of the aircraft; and
a second compressor configured to produce a second quantity of compressed air onboard the aircraft and being operatively connected to:
supply the second quantity of compressed air to the cabin of the aircraft when an altitude of the aircraft is above a threshold altitude; and
supply the second quantity of compressed air to an ice protection device of the aircraft when the altitude of the aircraft is below the threshold altitude.

2. The apparatus as defined in claim 1, wherein the first compressor is configured to receive ram air to produce the first quantity of compressed air.

3. The apparatus as defined in claim 1, wherein the second compressor is configured to receive ram air to produce the second quantity of compressed air.

4. The apparatus as defined in claim 1, comprising an electric motor for driving the first compressor.

5. The apparatus as defined in claim 1, comprising an electric motor for driving the second compressor.

6. The apparatus as defined in claim 1, comprising a heat exchanger configured to facilitate heat transfer from the first quantity of compressed air upstream of the cabin to a quantity of cooling air, wherein the ice protection device is operatively connected to receive the heated quantity of cooling air from the heat exchanger.

7. The apparatus as defined in claim 6, comprising a third compressor configured to compress the heated quantity of cooling air upstream of the ice protection device.

8. The apparatus as defined in claim 7, comprising a mixing chamber configured to receive the compressed heated quantity of cooling air from the third compressor and the second quantity of compressed air to provide a mixed quantity of air for ice protection.

9. The apparatus as defined in claim 1, comprising:
a heat exchanger configured to facilitate heat transfer from the first quantity of compressed air upstream of the cabin to a quantity of cooling air, the ice protection device being operatively connected to receive the heated quantity of cooling air from the heat exchanger;
a third compressor configured to compress the heated quantity of cooling air upstream of the ice protection device; and
an electric motor for driving the third compressor.

10. The apparatus as defined in claim 6, wherein the cooling air is ram air.

11. The apparatus as defined in claim 1, wherein the first compressor and the second compressor are non-aircraft-engine compressors.

12. An aircraft comprising the apparatus as defined in claim 1.

13. A method for providing air to pneumatic loads onboard an aircraft, the method comprising:
producing a first quantity of compressed air using a first compressor onboard the aircraft;
using the first quantity of compressed air to control an environment inside a cabin of the aircraft;
producing a second quantity of compressed air using a second compressor onboard the aircraft;
using the second quantity of compressed air to control the environment inside the cabin of the aircraft when an altitude of the aircraft is above a threshold altitude; and
using the second quantity of compressed air for ice protection when the altitude of the aircraft is below the threshold altitude.

14. The method as defined in claim 13, comprising receiving ram air at the first compressor to produce the first quantity of compressed air.

15. The method as defined in claim 13, comprising receiving ram air at the second compressor to produce the second quantity of compressed air.

16. The method as defined in claim 13, comprising driving the first compressor using an electric motor.

17. The method as defined in claim 13, comprising driving the second compressor using an electric motor.

18. The method as defined in claim 13, comprising:
transferring heat from the first quantity of compressed air to a quantity of cooling air prior to using the first quantity of compressed air to control the environment inside the cabin of the aircraft; and
using the heated quantity of cooling air for ice protection.

19. The method as defined in claim 18, comprising compressing the heated quantity of cooling air using a third compressor before using the compressed heated quantity of cooling air for ice protection.

20. The method as defined in claim 19, comprising:
mixing the compressed heated quantity of cooling air with the second quantity of compressed air to provide a mixed quantity of air; and
using the mixed quantity of air for ice protection.

21. The method as defined in claim 13, comprising:
transferring heat from the first quantity of compressed air to a quantity of cooling air prior to using the first quantity of compressed air to control the environment inside the cabin of the aircraft;
compressing the heated quantity of cooling air using a third compressor driven by an electric motor; and
using the compressed heated quantity of cooling air for ice protection.

22. The method as defined in claim 18, wherein the cooling air is ram air.

23. The method as defined in claim 13, wherein the first compressor and the second compressor are non-aircraft-engine compressors.

24.-44. (canceled)
